(19) United States
(12) Patent Application Publication
(10) Pub. No.: US 2023/0005479 A1
(43) Pub. Date: Jan. 5, 2023

(54) METHOD FOR PROCESSING AN AUDIO STREAM AND CORRESPONDING SYSTEM

(71) Applicant: PRAGMA ETIMOS S.R.L., Latina (LT) (IT)

(72) Inventors: Gaetano LO PRESTI, Latina (LT) (IT); Fabio Vincenzo COLACINO, Anzio (RM) (IT); Ilaria IANNICOLA, Latina (LT) (IT)

(21) Appl. No.: 17/856,146

(22) Filed: Jul. 1, 2022

(30) Foreign Application Priority Data
Jul. 2, 2021 (IT) 102021000017513

(51) Int. Cl. G10L 15/22; G10L 25/24; G10L 15/30; G10L 25/51; G10L 21/0308; G10L 21/034; G10L 15/06; G10L 15/16

(52) U.S. Cl. CPC G10L 15/22; G10L 25/24; G10L 15/30; G10L 25/51; G10L 21/0308; G10L 21/034; G10L 15/063; G10L 15/16

(57) ABSTRACT

A method and a system for processing an audio stream are described, wherein at least one database of classified voices and at least one database of classified background sounds are provided and a comparison between these classified voices and background sounds with the voices and the sounds extrapolated from a suitably re-processed audio stream is carried out in order to identify possible matches.

### BENEFIT CLAIM

This application claims the benefit under 35 U.S.C. 119 of Italy patent application 102021000017513, filed Jul. 2, 2021, the entire contents of which are hereby incorporated by reference for all purposes as if fully set forth herein

### BACKGROUND

### Technical Field

The present disclosure relates to a method for processing an audio stream and a corresponding system.

The disclosure relates in particular, but not exclusively, to a method for processing an audio stream for the recognition of voices and/or background sounds, and the following description is made with reference to this field of application for the sole purpose of simplifying the disclosure thereof.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

As is well known, voice biometrics is a technology that allows people to be recognized through their voice.

This technology is increasingly being used thanks to the latest developments in multimedia data processing, which have led to the creation of hardware and software tools capable of handling large amounts of such data very quickly.

In particular, of great interest in this area are the so-called “smart conversational systems”, able to obtain information starting from a phone contact thanks to the biometric recognition of the voice and the consequent identification of people through the voice.

It is possible to use such voice identification in business to increase the level of personalization of the services delivered over the phone, e.g. through the so-called call or contact centers, reducing the time that is normally spent at the beginning of the contact to collect caller's data, thereby improving the overall customer experience.

Voice biometrics can be also used in the “security” field to facilitate physical access to gates, e.g. of controlled areas such as a police station, or to allow computer access to programs or Internet platforms, to create voice signatures with which to sign documents or authorize financial transactions, or even to allow access to personal data such as health data or confidential information by the public administration, with guaranteed security of access and with respect for the privacy of the data of the users involved. The main advantage of voice biometrics consists in that it is difficult to be counterfeited and can easily be combined with other recognition factors, thus increasing the level of security that can be achieved.

The development of solutions using the identification of a person by voice in such diverse fields has also made increasingly sophisticated software available for processing and handling multimedia data, in particular comprising sounds, also referred to as audio files or streams.

Some of this software is also used in the legal field for the management of interceptions, whether by phone or environmental, which however suffer greatly from the lack of sharpness of the collected sounds and the presence of background sounds.

### BRIEF SUMMARY

The method for processing an audio stream is able to correctly recognize the voices and/or background sounds contained in the audio stream, overcoming the limitations and drawbacks that still afflict methods according to the prior art. According to an aspect of the disclosure, at least one database of classified voices and at least one database of classified background sounds are provided and a comparison between these classified voices and background sounds with the voices and the sounds extrapolated from a suitably re-processed audio stream is carried out in order to identify possible matches.

The method for processing an audio stream may comprise the steps of:
receiving an audio stream signal;
providing at least one database comprising voice models and/or background sound models classified based on at least one characteristic parameter of model signals;
processing the audio stream signal by dividing it in a plurality of audio frames classified in a plurality of voice frames and in a plurality of background sound frames;
extracting the characteristic parameter from the plurality of voice frames and from the plurality of background sound frames;
comparing the characteristic parameters of said voice frames and of background sound frames contained in the audio stream signal with the classified voice models and/or background sound models contained in the database; and
generating a result comprising at least one matching percentage of the voice frames and the background sound frames with one or more voice models and/or background sound models of the database.

According to another aspect of the disclosure, the step of processing audio stream signal may use at least one voice recognition algorithm for classifying the voice frames and the background sound frames, one frame containing both voice and background sound being preferably classified as a voice frame.

Furthermore, according to a further aspect of the disclosure, the characteristic parameter extracted from the frames can be the MEL and the step of extracting generates numeric arrays corresponding to the voice frames and background sound frames extracted from the audio stream signal, which are compared to corresponding numeric arrays of the classified voice models and classified background sound models stored in the database.

According to another aspect of the disclosure, the method may further comprise a step of generating an output signal following the step of generating the result, said output signal preferably comprising a graphic representation of the at least one matching percentage comprised in the result and possibly the audio frames which were extracted and possibly processed by the audio stream signal.

The method may also further comprise a step of pre-processing the audio stream signal, preferably adapted to normalize said signal by equalizing the volume thereof, with suitable increases and decreases based on the amplitude of the signal itself, said step of pre-processing preceding said step of processing and subdividing the audio stream signal into frames.

Furthermore, the method may comprise a step of post-processing the voice frames and the background sound frames extracted from the audio stream signal wherein the frequencies of the background sound frames are subtracted from the voice frames, said step of post-processing preceding the step of extracting the characteristic parameter.

According to another aspect of the disclosure, the step of providing at least one database may in turn comprise the steps of:
receiving a model audio signal, corresponding to a voice or a background sound of interest;
dividing the model audio signal in a plurality of voice frames or background sound frames;
eliminating frames which are not compatible with said model audio signal;
extracting the characteristic parameter of the identified frames and creating the classified voice model or the classified background sound model; and
storing the classified model in the at least one database.

According to another aspect of the disclosure, the step of creating a voice model or background sound model can be carried out by a neuronal model.

Furthermore, the method can use a platform of Machine Learning and a voice recognition model which is trained based on the characteristics of the model signals subjected to training.

A system for processing an audio stream is also provided, the system comprising:
a separation block adapted to receive an audio stream signal and divide it in a plurality of audio frames classified as appropriately separated voice frames and background sound frames;
a prediction and classification block adapted to receive the voice frames and the background sound frames and to extract at least one characteristic parameter therefrom; and
a storage system of classified audio signal models, comprising at least one database adapted to store classified voice models and/or classified background sound models,

such a storage system being connected to the prediction and classification block which carries out a comparison of the characteristic parameters of the voice frames and of the background sound frames contained in the audio stream signal with the classified voice models and/or classified background sound models stored in the database and generates a result comprising at least one matching percentage of the voice frames and/or the background sound frames with one or more voice models and/or background sound models of the database.

According to an aspect of the disclosure, the separation block may use at least one voice recognition algorithm for classifying voice frames and the background sound frames, one frame containing both voice and background sound being preferably classified as a voice frame.

Additionally, the prediction and classification block may extract the characteristic parameter MEL from the voice frames and from the background sound frames and generate numeric arrays corresponding to the voice frames and to the background sound frames, and the voice models and/or background sound models of said database may comprise corresponding numeric arrays tied to the characteristic parameter MEL of model signals used for creating the voice models and/or the background sound models.

The system may also comprise a generation block of an output signal, comprising a graphic representation of the at least one matching percentage comprised in the result and possibly the audio frames which were extracted and possibly processed by the audio stream signal.

According to another aspect of the disclosure, the system may further comprise a pre-processing block of the audio stream signal adapted to normalize said audio stream signal to equalize the volume thereof, with suitable increases and decreases based on the amplitude of the signal itself, before providing it to the separation block.

According to another aspect of the disclosure, the system may further comprise a post-processing block of the voice frames and of the background sound frames extracted from the audio stream signal by the separation block, said post-processing block subtracting the frequencies of the background sound frames from the voice frames before providing said frames to the prediction and classification block.

Furthermore, according to another aspect of the disclosure, the system may comprise a recognition and classification system of at least one model audio signal, corresponding to a voice or to a background sound of interest, in turn including:
a processing block, which receives the model audio signal and decomposes it in a plurality of voice frames or of background sound frames, eliminating the frames which are not compatible with the model audio signal; and
a modeling block adapted to extract the characteristic parameter from the frames generated by the processing block and create the classified voice or background sound model, to be stored in the database.

According to this aspect of the disclosure, the modeling block of the recognition and classification system can be based on a neuronal model.

Furthermore, such a modeling block of the recognition and classification system can extract the characteristic parameter MEL and generate a classified voice model or classified background sound model in the form of an array of numeric values, processed by Machine Learning algorithms.

The recognition and classification system may also comprise a pre-processing block, which receives the model audio signal and carries out the normalization thereof by equalizing the volume thereof before providing it to the processing block.

Finally, according to yet another aspect of the disclosure, the audio stream signal can be obtained by an environmental interception.

The characteristics and advantages of the method and system according to the disclosure will become clear from the description, made below, of an embodiment thereof, given by way of non-limiting example with reference to the attached drawings.

### BRIEF DESCRIPTION OF THE SEVERAL VIEWS OF THE DRAWINGS

FIG. 1: schematically shows a possible application to an environmental interception of a system for processing an audio stream according to the present disclosure;

FIG. 2: shows a system for processing an audio stream implementing the method according to the present disclosure used in the application of FIG. 1; and

FIGS. 3A and 3B: show recognition and classification systems for creating databases comprising classified voices and classified background sounds, respectively, used by the system of FIG. 2.

### DETAILED DESCRIPTION

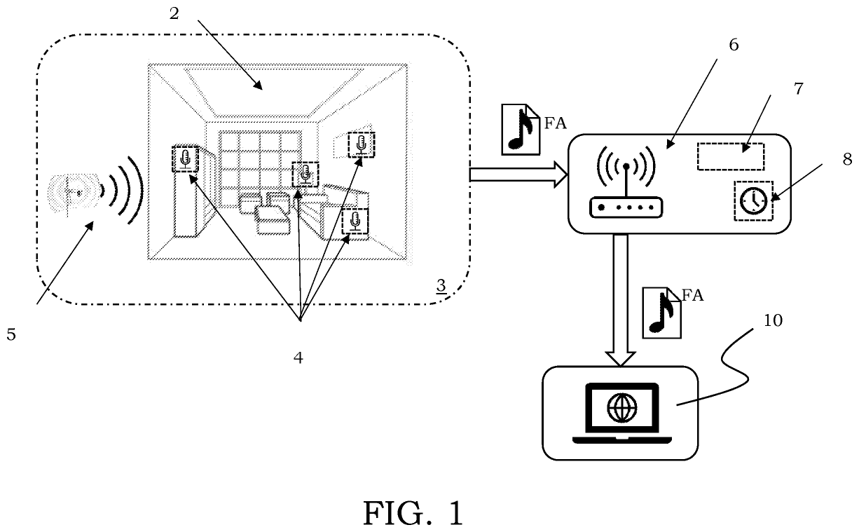

With reference to these figures, and in particular to FIG. 1, a system for processing an audio stream according to the present disclosure is indicated as a whole with 10, in the exemplary case of an application to an environmental interception.

It should be noted that the figures represent schematic views of the system according to the disclosure and of the elements thereof and are not drawn to scale, but are instead drawn in such a way as to emphasize the important features of the disclosure.

Furthermore, the elements that make up the illustrated system are only shown schematically.

Finally, the different aspects of the disclosure represented by way of example in the figures are obviously combinable with each other and interchangeable from one embodiment to another.

In particular, FIG. 1 shows the use of the system 10 for processing an audio stream when an audio stream signal FA is derived from an environmental interception. In this case, the audio stream signal FA comprises the sounds being in an environment 2, such as a room as illustrated in the figure, and is detected thanks to an audio detection system 3 that generates an audio stream signal FA.

In the example illustrated in FIG. 1, the audio detection system 3 comprises a plurality of audio detection microdevices 4 arranged within the environment 2, such as miniaturized microphones, in particular suitably hidden and/or positioned at points of acoustical interest. The audio detection system 3 may further comprise one or more remote audio detection devices, such as a directional microphone 5, suitably arranged to detect sounds from the environment 2, as shown in FIG. 1.

Obviously, it is also possible to consider an audio detection system 3 comprising various audio detection devices, chosen for example from a telephone, whether fixed or mobile, or a microphone integrated therein, a video camera provided with a microphone, a microphone integrated in a computer or in another hardware device such as a tablet or PDA device, an entertainment system for a home or a car, other types of microphone that may be placed in the environment 2 or capable of carrying out remote detections, however generating an audio stream signal FA.

Similarly, it is possible to use the system 10 for processing an audio stream signal on an audio stream signal FA detected from an environment 2 other than a room, such as a private enclosed place, like an entire flat, a shed or a work environment, a public enclosed place, such as a public building, a hotel or a museum, or an open, public or private place, such as a garden, a street, a square or a car park, only naming a few.

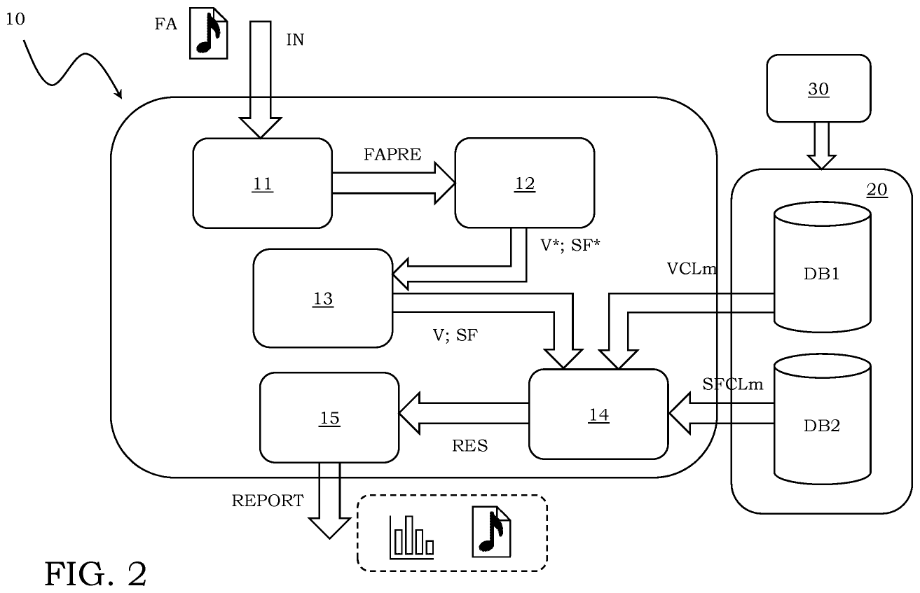

Suitably according to the present disclosure, the audio stream signal FA is transmitted, by means of a signal transceiver device 6, such as a router, to an audio stream processing system 10, adapted to suitably process the audio stream signal FA, as will be described in greater detail below with reference to FIG. 2.

The signal transceiver device 6 can also comprise storage means 7 adapted to store one or more audio stream signals FA prior to their transmission, and possibly timing means 8 capable of synchronizing the transmission of the stored audio stream signal(s) FA, e.g. according to predetermined and possibly modifiable timings.

Referring to FIG. 2, the system 10 for processing an audio stream receives as input an audio stream signal FA to be processed, also referred to as input signal IN. Such an audio stream signal FA may derive for example from an environmental interception, like in the example shown in FIG. 1.

The system 10 for processing an audio stream comprises at least a first block 11 of pre-processing the audio stream signal FA received as input, adapted to generate a pre-processed audio stream signal FAPRE. In particular, the first pre-processing block 11 is adapted to normalize the audio stream signal FA in order to equalize the volume thereof, with increases and decreases based on the amplitude of the signal, bringing possible peaks back to the same unit of measurement and thus making the voices or background sound contained therein more intelligible.

It is also possible to use the first pre-processing block 11 to perform other processing of the audio stream signal FA, e.g. filtering operations to eliminate any frequencies that are not of interest. Such operations for pre-processing the audio stream signal FA, while extremely useful, can be avoided, for example, in the case of signals with constant volume, and are therefore optional.

Suitably, the system for processing the audio stream 10 further comprises a second block 12 of separating the audio stream signal FA, adapted to receive the pre-processed signal FAPRE and divide it in a plurality of elementary units or audio frames; said second separation block 12 further identifying which frames belong to a voice signal and which frames belong to a background sound signal, classifying them as appropriately separated voice frames V* and background sound frames SF*. Obviously, in the event that the audio stream signal FA is not pre-processed, the second separation block 12 is able to operate directly on this audio stream signal FA, suitably provided to it as input, while still obtaining separated voice frames V* and background sound frames SF*.

This second separation block 12 uses at least one voice recognition algorithm for identifying the voice frames V* and the background sound frames SF*. Conventionally, an audio frame that contains both voice and background sound is classified as a voice frame V*, which substantially prevails over the background sound.

Suitably, the second separation block 12 may also eliminate the silence frames, i.e. comprising neither voice nor background sound, optimizing the process as a whole. In particular, silence frames are classified as such when the background sound, normally always present, is below a predetermined threshold.

The system 10 for processing an audio stream further comprises a third block 13 of post-processing the voice frames V* and the background sound frames SF* received from the second separation block 12, said third post-processing block 13 being adapted to generate corresponding pluralities of voice frames V and of background sound frames SF further processed.

Specifically, the third post-processing block 13 performs a subtraction of the frequencies of the background sound frames SF* from those that are the voice frames V*, thus cleaning the voice frames from the background sounds, if any, in a phase that is commonly referred to as Noise Reduction. This post-processing operation is optional, since the system may not comprise any third post-processing block 13 in the case, for example, of an audio stream signal FA with very little background sound, as might be the case with recordings made in quiet environments.

Advantageously according to the present disclosure, the system 10 for processing an audio stream also comprises a prediction and classification block 14, connected to the third post-processing block 13 from which it receives the voice frames V and the background sound frames SF further processed, in particular cleaned up as explained above. Appropriately, in the event that no post-processing operation is performed, the prediction and classification block 14 would receive the voice frames V* and the background sound frames SF* directly from the second separation block 12.

The prediction and classification block 14 initially performs the extraction of at least one characteristic parameter of audio frames, preferably the so-called MEL (Spectrogram Frequency), in particular an array of values obtained from the transformation of an audio frame from the time scale to the frequency scale by means of the mathematical formula of the Fourier transform.

In particular, the prediction and classification block 14 is connected to a system 20 for storing classified audio signal models, comprising at least a first database DB1 adapted to store a plurality of numeric arrays, corresponding to a series of characteristic parameters of suitable model or sample voice signals, referred to as classified voice models VCLm, and a second database DB2 adapted to store a plurality of numeric arrays, corresponding to a series of characteristic parameters of suitable model or sample background sound signals, referred to as classified background sound models SFCLm, as will be further described below; such classified voice models VCLm and classified background sound models SFCLm are suitably sent to the prediction and classification block 14. Preferably, the first database DB1 and the second database DB2 comprise numeric arrays with the values of MEL of the respective model signals.

The prediction and classification block 14 then carried out a comparison between arrays of numeric values corresponding to the plurality of voice frames V*, V and background sound frames SF*, SF detected and possibly re-processed starting from the audio stream signal FA, as explained above, with arrays of numeric values corresponding to classified voice models VCLm and classified background sound models SFCLm providing a matching percentage (or score), which allows the most probable matches among the signals involved to be predicted.

In this way, the prediction and classification block 14 is able to verify the voice frames V*, V and background sound frames SF*, SF extracted from the audio stream signal FA and possibly processed to detect a match with models being in the databases DB1 and DB2 and to provide a result RES, i.e. the voices and the sounds identified in the audio stream signal FA with the probability percentages of matching with respective models, in addition to the re-processed audio files comprising the frames on the basis of which the result RES was generated.

Finally, the system 10 for processing an audio stream comprises a fifth block 15 for generating an output signal REPORT, comprising in graphic form the matching percentages between the voices and the background sounds identified in the processed audio stream signal FA and those stored on the basis of model or sample signals, possibly also attaching the re-processed audio files.

The output signal REPORT may comprise, for example, all the detected voices with their percentages or only the detection of one or more voices of interest, or even a grouping of voices based on a background sound of interest. In particular, advantageously according to the present disclosure, having classified the background sound signals, it is possible to use them to identify groups of voices that have the same background sound signal; furthermore, thanks to the classification of the background sound signals, it is also possible to perform a kind of geolocalization of voice signals precisely on the basis of these background sound signals.

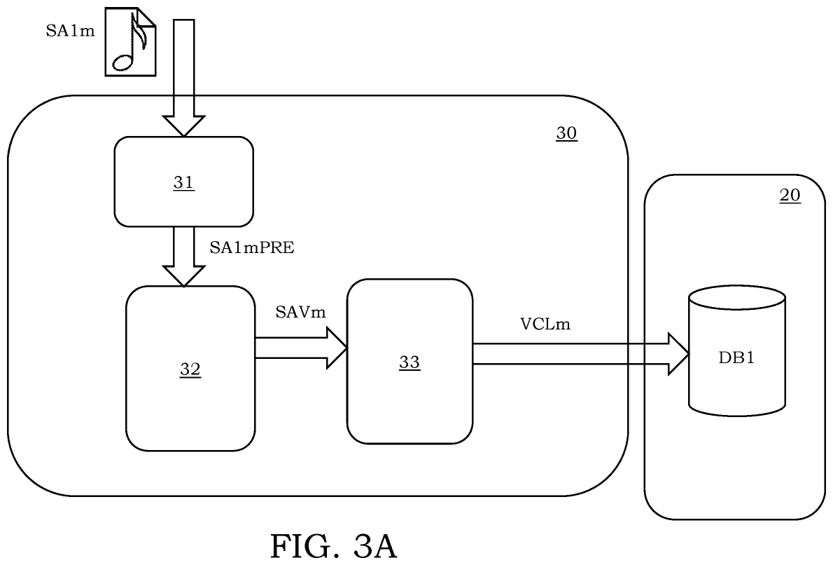

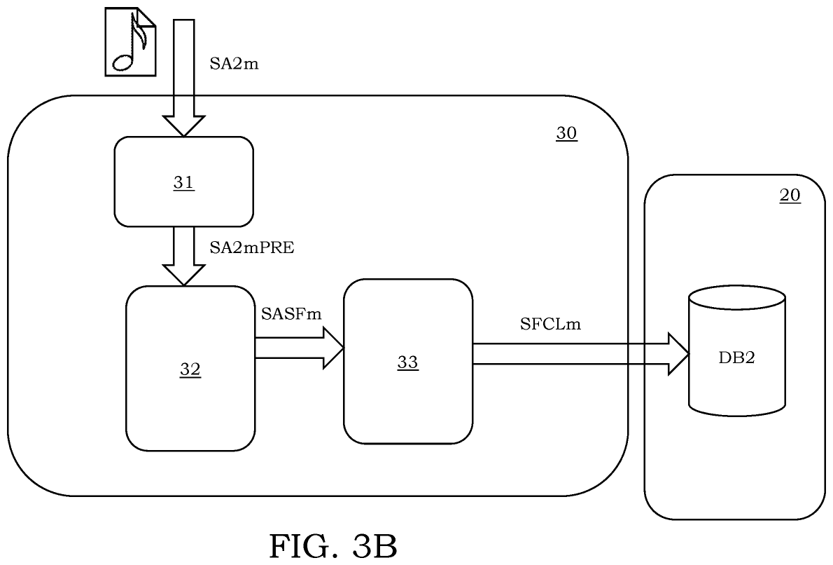

The classified voice models VCLm and the classified background sound models SFCLm are obtained thanks to a recognition and classification system 30, illustrated schematically in FIGS. 3A and 3B, for the voice and background sound signals, respectively. Suitably, the different processing to which the model signals are subjected essentially correspond to those applied to the audio stream signal FA to be processed, so as to be able to obtain characteristic parameters, in particular arrays of numeric values, actually comparable among them.

In a preferred embodiment of the disclosure, the recognition and classification system 30 is based on a neuronal model.

Suitably, as illustrated in FIG. 3A, the voice recognition and classification system 30 may receive a model or sample audio signal SA1m, in particular tied to a voice of interest.

The recognition and classification system 30 comprises a first pre-processing block 31, which receives the model audio signal SA1m and performs the normalization thereof, providing a pre-processed signal SA1mPRE to a second processing block 32, which decomposes it in a plurality of audio frames and separates the voice frames and the background sound frames, in addition to the silence frames; suitably, the background sound frames and possibly the silence frames are then eliminated, so as to filter out unnecessary data. The audio stream is then divided in a plurality of frames with equal duration, for example equal to 3 seconds, obtaining a plurality of voice frames, referred to as a signal SAVm. Also in this case, the operations for pre-processing the model audio signal SA1m may be optional, the second processing block 32 being able to directly decompose said model audio signal SA1m.

Appropriately, the recognition and classification system 30 further comprises a third modeling block 33, which is able to extract a characteristic parameter from the frames present in the signal SAVm, namely the parameter MEL In this way, the third modeling block 33 obtains an array of numeric values, which in fact constitute the classified voice model VCLm, processed thanks to Machine Learning algorithms.

Additionally, the third modelling block 33 stores the classified voice model VCLm in the first database DB1 of the classified audio signal storage system 20.

Similarly, as illustrated in FIG. 3B, the voice recognition and classification system 30 may receive a model or sample audio signal SA2m tied to a background sound.

In such a case, the first (however optional) pre-processing block 31 performs the normalization of the model audio signal SA2m and provides a processed signal SA2mPRE to the second processing block 32, which in turn decomposes it in a plurality of audio frames and separates the voice frames and the background sound frames, in addition to the silence frames; appropriately, the voice frames and the silence frames are then eliminated, so as to filter out superfluous data and obtain a plurality of background sound frames, referred to as the signal SASFm, for the third modeling block 33.

Furthermore, the third modeling block 33 re-processes the signal SASFm, in particular by extracting again the parameter MEL of the frames composing it, and obtains a classified background sound model SFCLm adapted to be stored in the second database DB2 of the system 20 for storing classified audio signals.

Appropriately, the system 10 for processing an audio stream is thus able to recognize a voice or background sound by comparing it to a classified neuronal model of voices and background sounds.

The present disclosure also refers to a method for processing an audio stream adapted to obtain a classification of the sounds contained therein, implemented by the system 10 for processing an audio stream described above.

Specifically, this method for processing an audio stream comprises the steps of:
receiving an audio stream signal FA;
providing at least one database DB1, DB2 comprising voice models VCLm/or background sound models SFCLm classified based on at least one characteristic parameter of model signals;
processing the audio stream signal FA by dividing the same in a plurality of audio frames classified in a plurality of voice frames V*, V and in a plurality of background sound frames SF*, SF;
extracting said characteristic parameter from the plurality of voice frames V*, V and from the plurality of background sound frames SF*, SF;
comparing the characteristic parameters of the voice frames V*, V and of the background sound frames SF*, SF contained in the audio stream signal FA with the classified voice models VCLm or classified background sound models SFCLm contained in the database DB1, DB2; and
generating a result RES comprising one matching percentage of the voice frames V*, V and the background sound frames SF*, SF with one or more classified voice models VCLm and/or background sound SFCLm.

Appropriately, the step of processing the audio stream signal FA uses at least one voice recognition algorithm for classifying the voice frames V*, V and the background sound frames SF*, SF. Preferably, when a frame contains both voice and background sound, it is still classified as a voice frame V*, V.

In a preferred embodiment, the characteristic parameter extracted from the signals is the MEL and the extraction step generates numeric arrays corresponding to the voice frames V*, V and the background sound frames SF*, SF, which are compared with corresponding numeric arrays of the models stored in the databases DB1, DB2, these array of values being obtained by transforming an audio frame from the time scale to the frequency scale, using the mathematical formula of the Fourier transform.

Suitably, the method may also comprise a final step of generating an output signal REPORT comprising a graphic representation of the matching percentages comprised in the result RES and possibly the audio frames that were extracted and processed from the audio stream signal FA. The output signal REPORT can comprise other ways of aggregating the values comprised in the result RES, e.g. providing only the model for voice or background sound that has the highest percentage, or all models that have a percentage above a pre-set threshold.

Appropriately, the method for processing an audio stream may also comprise at least one step of pre-processing the audio stream signal FA, preferably adapted to normalize said audio stream signal FA by equalizing the volume thereof, with suitable increases and decreases based on the amplitude of the signal itself, said step of pre-processing preceding the step of processing and subdividing the audio stream signal FA into frames.

The method for processing an audio stream may also comprise a step of post-processing the voice frames V*, V and the background sound frames SF*, SF extracted from the audio stream signal FA, wherein the frequencies of the background sound frames SF*, SF are subtracted from the voice frames V*, V, obtaining a cleaning of the voice frames V* in a so-called Noise Reduction operation.

Appropriately, the step of providing at least one database DB1, DB2 comprises in particular the following steps of:
receiving a model audio signal SA1m, SA2m corresponding to a voice or a background sound of interest;

dividing the model audio signal SA1m, SA2m in a plurality of voice frames or background sound frames;
eliminating the frames which are not compatible with the model audio signal SA1m, SA2m, i.e. eliminating the background sound frames in the case of a model audio signal SA1m tied to a voice and eliminating the voice frames in the case of a model audio signal SA2m tied to a background sound signal;
extracting a characteristic parameter from the identified frames and creating a classified voice model VCLm or a classified background sound model SFCLm; and
storing the classified model VCLm, SFCLm in a database DB1, DB2.

In a preferred embodiment, the step of creating a voice model or background sound model is carried out by a neuronal model.

Appropriately, the step of extracting the characteristic parameter from the frames identified in the model signal comprises a step of extracting the parameter MEL and the step of creating the model comprises the creation of an array of numeric values.

Additionally, a step of pre-processing the model signal prior to the separation thereof into frames can be envisaged, e.g. a normalization of this model signal by making the volume thereof uniform.

As explained above, such classified voice models VCLm and classified background sound models SFCLm being in the database DB1, DB2 are used in the step of comparing the voice frames V*, V or background sounds SF*, SF contained in the audio stream signal FA in the method for processing an audio stream according to the present disclosure.

In a preferred embodiment, the method uses a platform of Machine Learning and a model on which recognition is implemented, which is trained on the basis of the characteristics of the samples subjected to training.

More in particular, an audio sampling with frames of a predetermined minimum duration (equal to for example one minute) is performed on voices or background sounds of interest.

It is also possible to use one or more of the following parameters as a characteristic parameter extracted from the frames for comparison via audio processing libraries:
MFCC (Mel Frequency Cepstral Coefficient) features extraction: time-dependent calculation of the vocal spectrum power;
Chroma: the pitch classes of the sounds;
Phonetic contrast: the minimal phonetic distinction between one pronunciation and another (for example P and B) in the language; and
Tonnetz: the tonal space of the sounds.

Advantageously, therefore, thanks to the system for processing an audio stream according to the present disclosure, if a recording of a sample voice or a voice of interest is in the model or sample audio signal, it will be detected whenever an audio stream signal FA comprising that voice is processed.

Similarly, advantageously, the system for processing an audio stream according to the present disclosure makes it possible to extend the recognition to all voices having a certain background sound in common, always identified on the basis of a model or sample audio signal tied to that background sound.

It is emphasized that, advantageously in the method and in the system according to the present disclosure, the background sound, normally eliminated from the audio stream signals in the current voice recognition techniques, is instead used as an additional unit of information that makes it possible, for example, to aggregate voices that are even not in the sample voice models due to the presence of a background sound that is instead recognized.

From the foregoing it will be appreciated that, although specific embodiments of the disclosure have been described herein for purposes of illustration, various modifications may be made without deviating from the spirit and scope of the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

For example, it is possible to use the method and the system for analyzing audio files detected in real time or applying them to previously recorded files.

Furthermore, other pitch classes can be envisaged, e.g. to distinguish repetitive noises from random noises or from possible disturbances in the transceiver line of the audio stream signal to be analyzed.

Finally, it is possible to use the method for analyzing a plurality of audio stream signals, either simultaneously or sequentially, obtaining a single output signal that collectively illustrates the results of this analysis.

1. A method for processing an audio stream comprising the steps of:
receiving an audio stream signal;
providing at least one database comprising voice models and/or background sound models classified based on at least one characteristic parameter of model signals;
processing the audio stream signal by dividing it in a plurality of audio frames classified in a plurality of voice frames and in a plurality of background sound frames;
extracting the characteristic parameter from the plurality of voice frames and from the plurality of background sound frames;
comparing the characteristic parameters of the voice frames and of the background sound frames contained in the audio stream signal with the classified voice models and/or classified background sound models contained in the database; and
generating a result comprising at least one matching percentage of the voice frames and the background sound frames with one or more voice models and/or background sound models of the database.

2. The method of claim 1, wherein the step of processing audio stream signal uses at least one voice recognition algorithm for classifying the voice frames and the background sound frames, a frame containing both voice and background sound being classified as a voice frame.

3. The method of claim 1, wherein the characteristic parameter extracted from the frames is the MEL and wherein the step of extracting generates numeric arrays corresponding to the voice frames and the background sound frames extracted from the audio stream signal, which are compared to the corresponding numeric arrays of the classified voice models and classified background sound models stored in the database.

4. The method of claim 1, further comprising a step of generating an output signal following the step of generating the result, the output signal comprising a graphic representation of the at least one matching percentage comprised in the result.

5. The method of claim 1, further comprising a step of pre-processing the audio stream signal adapted to normalize the signal by equalizing the volume thereof, with suitable increases and decreases based on the amplitude of the signal itself, the step of pre-processing preceding the step of processing and subdividing the audio stream signal into frames.

6. The method of claim 1, further comprising a step of post-processing the voice frames and the background sound frames extracted from the audio stream signal, wherein the frequencies of the background sound frames are subtracted from the voice frames, the step of post-processing preceding the step of extracting the characteristic parameter.

7. The method of claim 1, wherein the step of providing at least one database in turn comprises the steps of:
receiving a model audio signal, corresponding to a voice or a background sound of interest;
dividing the model audio signal in a plurality of voice frames or background sound frames;
eliminating frames which are not compatible with the model audio signal;
extracting the characteristic parameter of the identified frames and creating the classified voice model or the classified background sound model, respectively; and
storing the classified model in the at least one database.

8. The method of claim 7, wherein the step of creating a voice model or background sound model is carried out by a neuronal model.

9. The method of claim 7, using a platform of Machine Learning and a voice recognition model which is trained based on the characteristics of the model signals subjected to training.

10. A system for processing an audio stream of the type comprising:
a separation block adapted to receive an audio stream signal and divide it in a plurality of audio frames classified as appropriately separated voice frames and background sound frames;
a prediction and classification block adapted to receive the voice frames and the background sound frames and to extract at least one characteristic parameter therefrom; and
a storage system of classified audio signal models, comprising at least one database adapted to store classified voice models and/or classified background sound models,
the storage system being connected to the prediction and classification block which carries out a comparison of the characteristic parameters of the voice frames and of the background sound frames contained in the audio stream signal with the classified voice models and/or classified background sound models stored in the database and generates a result comprising at least one matching percentage of the voice frames and/or the background sound frames with one or more voice models and/or background sound models of the database.

11. The system of claim 10, wherein the separation block uses at least one voice recognition algorithm for classifying the voice frames and the background sound frames, one frame containing both voice and background sound being classified as voice frame.

12. The system of claim 10, wherein the prediction and classification block extracts the characteristic parameter MEL from the voice frames and from the background sound frames and generates numeric arrays corresponding to the voice frames and to the background sound frames and wherein the voice models and/or background sound models of the database comprise corresponding numeric arrays tied to the characteristic parameter MEL of model signals used for creating the voice models and/or the background sound models.

13. The system of claim 10, further comprising a generation block of an output signal, comprising a graphic representation of the at least one matching percentage comprised in the result.

14. The system of claim 10, further comprising a pre-processing block of the audio stream signal adapted to normalize the audio stream signal to equalize the volume thereof, with suitable increases and decreases based on the amplitude of the signal itself, before providing it to the separation block.

15. The system of claim 10, further comprising a post-processing block of the voice frames and of the background sound frames extracted from the audio stream signal by the separation block, the post-processing block subtracting the frequencies of the background sound frames from the voice frames before providing the frames to the prediction and classification block.

16. The system of claim 10, further comprising a recognition and classification system of at least one model audio signal, corresponding to a voice or to a background sound of interest, in turn including:
a processing block, which receives the model audio signal and decomposes it in a plurality of voice frames or of background sound frames, eliminating the frames which are not compatible with the model audio signal; and
a modeling block adapted to extract the characteristic parameter from the frames generated by the processing block and create the classified voice or background sound model, to be stored in the database.

17. The system of claim 16, wherein the modeling block of the recognition and classification system is based on a neuronal model.

18. The system of claim 16, wherein the modeling block of the recognition and classification system extracts the characteristic parameter MEL and generates a classified voice or background sound model in the form of an array of numeric values, processed by Machine Learning algorithms.

19. The system of claim 16, wherein the recognition and classification system further comprises a pre-processing block, which receives the model audio signal and carries out a normalization thereof by equalizing volume thereof before providing it to the processing block.

20. The system of claim 10, wherein the audio stream signal is obtained by an environmental interception.
